(19) United States
(12) Patent Application Publication
(10) Pub. No.: US 2015/0147627 A1
(43) Pub. Date: May 28, 2015

(54) RECHARGEABLE LITHIUM BATTERY

(71) Applicant: SAMSUNG SDI CO., LTD., Yongin-si (KR)

(72) Inventor: Yasuo TAKANO, Yokohama-shi (JP)

(21) Appl. No.: 14/551,552

(22) Filed: Nov. 24, 2014

(30) Foreign Application Priority Data
Nov. 25, 2013 (JP) 2013-243280
Nov. 25, 2013 (JP) 2013-243290
Nov. 6, 2014 (KR) 10-2014-0153510

(51) Int. Cl. H01M 2/16

(52) U.S. Cl. CPC H01M 2/1686; H01M 2/1653
USPC 429/144

(57) ABSTRACT

A rechargeable lithium battery includes a negative electrode including a negative active material layer and a separator including a substrate and a coating layer formed on at least one of the substrate. The coating layer includes a fluorine-based polymer. The at least one coating layer faces the negative active material layer. The negative active material layer includes a negative active material, a water-soluble polymer and a fluorine-based polymer particulate.

### CROSS-REFERENCE TO RELATED APPLICATIONS

Japanese Patent Application Nos. 2013-243290 and 2013-243280, filed on Nov. 25, 2013, in the Japanese Patent Office, and Korean Patent Application No. 10-2014-0153510, filed on Nov. 6, 2014, in the Korean Intellectual Property Office, and entitled: “Rechargeable Lithium Battery,” are incorporated by reference herein in their entirety.

### BACKGROUND

1. Field

Embodiments relate to a rechargeable lithium battery.

2. Description of the Related Art

With the rapid propagation of mobile tablets and smart phones, a rechargeable battery having a high capacity and slim size has become desirable. In addition, a battery may include environmentally friendly materials.

### SUMMARY

Embodiments are directed to a rechargeable lithium battery including a negative electrode including a negative active material layer, and a separator including a substrate and a coating layer formed on at least one side of the substrate. The coating layer includes a fluorine-based polymer. The coating layer faces the negative active material layer. The negative active material layer includes a negative active material, a water-soluble polymer and a fluorine-based polymer particulate.

The fluorine-based polymer particulate may be included in the negative active material layer in an amount of about 1 wt % to about 10 wt % based on the total amount of the negative active material layer.

The fluorine-based polymer particulate may be adhered to an outermost surface of the negative active material layer.

The fluorine-based polymer particulate and the fluorine-based polymer may independently be polyvinylidene fluoride (PVDF), a vinylidenefluoride (VDF)-hexafluoropropylene (HFP) copolymer, a vinylidenefluoride (VDF)-tetrafluoroethylene (TFE) copolymer, a vinylidenefluoride (VDF)-tetrafluoroethylene (TFE)-hexafluoropropylene (HFP) copolymer, or a combination thereof.

The fluorine-based polymer particulate may be obtained by emulsion polymerization of a monomer providing the fluorine-based polymer.

The fluorine-based polymer particulate may be obtained by pulverizing agglomerated particles synthesized by suspension polymerization of a monomer providing the fluorine-based polymer.

The water-soluble polymer may include a cellulose-based polymer.

The cellulose-based polymer may include a metal salt of carboxymethyl cellulose.

The negative active material may include a silicon-based material, a carbon-based material or a combination thereof.

The silicon-based material may include a silicon oxide represented by SiOₓ, (0.5≦x≦1.5).

The fluorine-based polymer may be a gel-type polymer swelled by a non-aqueous electrolyte.

The rechargeable lithium battery may further include a case that houses the negative electrode and the separator, the case being formed of an aluminum laminate film.

### BRIEF DESCRIPTION OF THE DRAWINGS

Features will become apparent to those of skill in the art by describing in detail exemplary embodiments with reference to the attached drawings in which:

FIG. 1 illustrates a perspective view showing an external configuration of a rechargeable lithium battery according to an embodiment.

FIG. 2 illustrates a cross sectional side view schematically showing the internal configuration of the rechargeable lithium battery according to an embodiment.

FIG. 3 illustrates a scanning electron microscope (SEM) image showing a negative electrode mass after compression according to Example 1.

FIG. 4 illustrates a scanning electron microscope (SEM) image showing a negative electrode mass after being heat-treated at 170° C. after the compression according to Example 1.

FIG. 5 illustrates a scanning electron microscope (SEM) image showing a negative electrode mass after compression according to Example 6.

FIG. 6 illustrates a scanning electron microscope (SEM) image showing a negative electrode mass heat-treated at 170° C. after the compression according to Example 6.

FIG. 7 illustrates a graph showing the correlation between the indenter deflection and the load (strength of test) loaded in the indenter in the buckling test of a rechargeable lithium battery.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

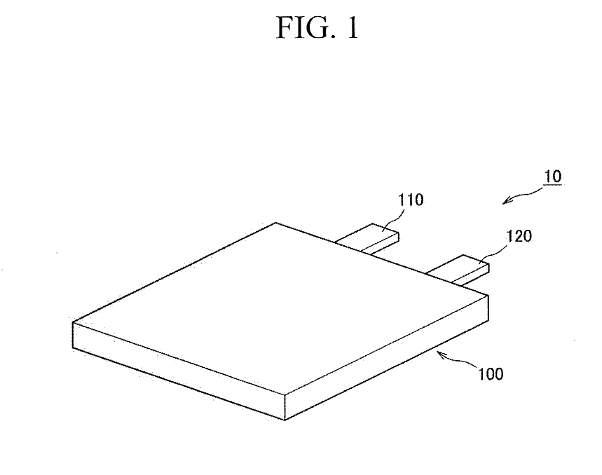

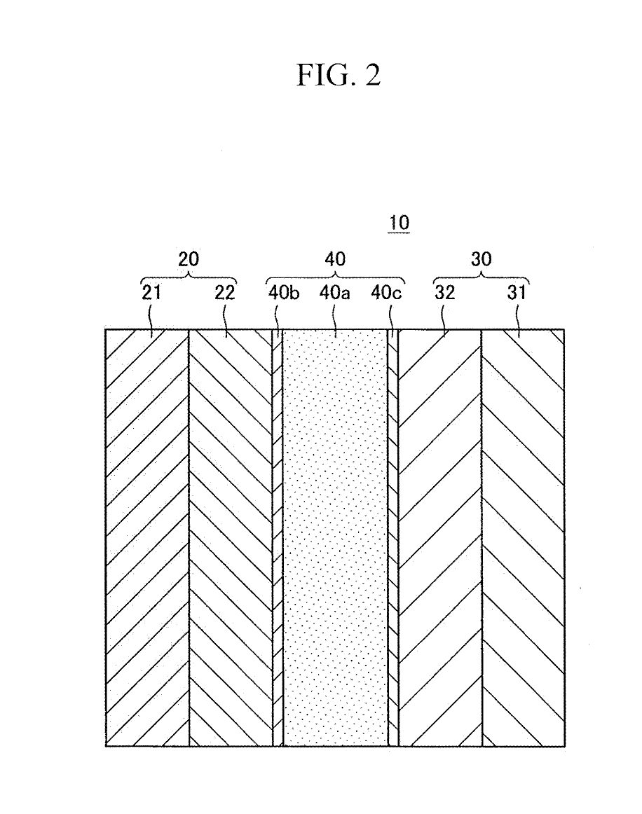

Hereinafter, a rechargeable lithium battery according to an embodiment is described with reference to FIGS. 1 and 2.

FIG. 1 is a perspective view showing an external configuration of a rechargeable lithium battery, and FIG. 2 is a cross sectional side view schematically showing internal configuration of the rechargeable lithium battery, according to an embodiment.

Referring to FIGS. 1 and 2, the rechargeable lithium battery 10 according to an embodiment may include a positive electrode 20, a negative electrode 30, a separator 40, a case 100, a positive current collector tab 110 and a negative current collector tab 120.

The separator 40 may include a substrate 40a and a coating layer formed on at least one side of the substrate 40a. For example, the coating layer may include a first coating layer 40b facing toward the positive electrode and a second coating layer 40c facing toward the negative electrode.

The substrate 40a may be formed of, for example, a porous film, a non-woven fabric, or the like, having excellent high-rate discharge performance by itself or in a combination.

The substrate 40a may include a resin such as, for example, a polyolefin-based resin, a polyester-based resin, a polyvinylidene fluoride (PVDF), a vinylidenefluoride-hexafluoropropylene copolymer, a vinylidenefluoride-perfluorovinylether copolymer, a vinylidenefluoride-tetrafluoroethylene copolymer, a vinylidenefluoride-trifluoroethylene copolymer, a vinylidenefluoride-fluoroethylene copolymer, a vinylidenefluoride-hexafluoroacetone copolymer, a vinylidenefluoride-ethylene copolymer, a vinylidenefluoride-propylene copolymer, a vinylidenefluoride-trifluoropropylene copolymer, a vinylidenefluoride-tetrafluoroethylene-hexafluoropropylene copolymer, a vinylidenefluoride-ethylene-tetrafluoroethylene copolymer, or the like. Examples of the polyolefin-based resin may include polyethylene, polypropylene, or the like. Examples of the polyester-based resin may include polyethylene terephthalate, polybutylene terephthalate, or the like.

The first coating layer 40b facing toward the positive electrode may be formed on the surface of the substrate 40a that faces the positive electrode 20 and, for example, faces a positive active material layer 22. The first coating layer 40b may be swollen by a non-aqueous electrolyte and may be turned into a gel-type layer. For example, the first coating layer 40b may include the gel-type non-aqueous electrolyte.

The first coating layer 40b may bind the separator 40 with the positive electrode 20, for example, with the positive active material layer 22. The first coating layer 40b may include a gel-type fluorine-based polymer swollen by the non-aqueous electrolyte.

The fluorine-based polymer of the first coating layer 40b may be, for example, polyvinylidene fluoride (PVDF), a vinylidenefluoride (VDF)-hexafluoropropylene (HFP) copolymer, a vinylidenefluoride (VDF)-tetrafluoroethylene (TFE) copolymer, a vinylidenefluoride (VDF)-tetrafluoroethylene (TFE)-hexafluoropropylene (HFP) copolymer, or the like. These may be used singularly or as a mixture of two or more. If the vinylidenefluoride (VDF)-hexafluoropropylene (HFP) copolymer is used, a weight ratio between vinylidenefluoride and hexafluoropropylene may be adjusted to a degree that the fluorine-based polymer is not dissolved in the non-aqueous electrolyte.

According to an embodiment, the first coating layer 40b facing toward the positive electrode may be omitted.

The second coating layer 40c facing toward the negative electrode may be formed on the surface of the substrate 40a that faces the negative electrode 30, for example, that faces, a negative active material layer 32. The second coating layer 40c may be a gel type layer swollen by the non-aqueous electrolyte. For example, the second coating layer 40c may include the gel-type non-aqueous electrolyte.

The second coating layer 40c may bind the separator 40 with the negative electrode 30, for example, with the negative active material layer 32. The second coating layer 40c may include a gel-type fluorine-based polymer swollen by the non-aqueous electrolyte.

The fluorine-based polymer of the second coating layer 40c may be, for example, polyvinylidene fluoride (PVDF), a vinylidenefluoride (VDF)-hexafluoropropylene (HFP) copolymer, a vinylidenefluoride (VDF)-tetrafluoroethylene(TFE) copolymer, a vinylidenefluoride (VDF)-tetrafluoroethylene(TFE)-hexafluoropropylene (HFP) copolymer. These may be used singularly or as a mixture of two or more. If the vinylidenefluoride (VDF)-hexafluoropropylene (HFP) copolymer is used, a weight ratio between vinylidenefluoride and hexafluoropropylene may be adjusted to a degree that the fluorine-based polymer is not dissolved in the non-aqueous electrolyte.

The non-aqueous electrolyte may include a suitable non-aqueous electrolyte for use in a rechargeable lithium battery. The non-aqueous electrolyte may have a composition that an electrolytic salt is contained in a non-aqueous solvent.

The non-aqueous solvent may be, for example, a cyclic carbonate ester such as propylene carbonate, ethylene carbonate, butylene carbonate, chloroethylene carbonate, vinylene carbonate, or the like; a linear carbonate such as dimethyl carbonate, diethyl carbonate, ethylmethyl carbonate, or the like; a cyclic ester such as γ-butyrolactone, γ-valerolactone, or the like; a linear ester such as methyl formate, methyl acetate, butyric acid methyl, or the like; tetrahydrofuran or a derivative thereof; an ether such as 1,3-dioxane, 1,4-dioxane, 1,2-dimethoxy ethane, 1,4-dibutoxyethane, methyl diglyme or the like; a nitrile such as acetonitrile, benzonitrile, or the like; a dioxolane or a derivative thereof; an ethylene sulfide, sulfolane, sultone or a derivative thereof. These may be used singularly or as a mixture of two or more.

The electrolytic salt may be, for example, an inorganic ionic salt including lithium (Li), sodium (Na) or potassium (K) such as LiClO₄, LiBF₄, LiAsF₆, LiPF₆, LiPF₆₋ₓ(CnF₂ₙ₊₁)ₓ (1<x<6, n=1 or 2), LiSCN, LiBr, LiI, Li₂SO₄, Li₂B₁₀Cl₁₀, NaClO₄, NaI, NaSCN, NaBr, KClO₄, KSCN or the like. The electrolytic salt may be, for example, an organic ion salt such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, (CH₃)₄NBF₄, (CH₃)₄NBr, (C₂H₅)₄NClO₄, (C₂H₅)₄NI, (C₃H₇)₄NBr, (n-C₄H₉)₄NClO₄, (n-C₄H₉)₄NI, (C₂H₅)₄N-maleate, (C₂H₅)₄N-benzoate, (C₂H₅)₄N-phthalate, stearyl sulfate, lithium octyl sulfate, lithium dodecylbenzene sulfonate, or the like. The electrolytic salts described above may be used singularly or as a mixture of two or more.

A concentration of the electrolytic salt may be, for example, about 0.8 mol/L to about 1.5 mol/L.

The negative electrode 30 includes a negative current collector 31 and a negative active material layer 32 formed on the negative current collector 31.

The negative current collector 31 may include a suitable material as a conductor. Examples thereof may include aluminum, copper, stainless steel, nickel plating steel or the like. The negative current collector 31 is connected to a negative current collector tab 120.

The negative active material layer 32 may include a negative active material, a water-soluble polymer and a fluorine-based polymer particulate.

The negative active material may be a suitable material being capable of intercalating and deintercalating lithium ions electrochemically. For example, the negative active material may be a carbon-based material, a silicon-based material, a tin-based material, or a lithium metal oxide. These may be used may be used singularly or as a mixture of two or more.

For example, the carbon-based material and the silicon-based material may be mixed. According to an embodiment, the fluorine-based polymer particulate in the negative active material layer may firmly bind the negative active materials and thus, suppress contraction and expansion of the silicon-based material. For example, the fluorine-based polymer particulate may suppress expansion and contraction of the silicon-based material during charge and discharge cycles, and may suppress a volume change of a rechargeable lithium battery during the charging and discharging such that the rechargeable lithium battery has a small thickness change. If the silicon-based material expands, the fluorine-based polymer particulate expands together therewith, and if the silicon-based material contracts, the fluorine-based polymer particulate contract with it. Therefore, linkage of the negative active materials including the silicon-based material may be maintained. Accordingly, the fluorine-based polymer particulate may help prevent structural destruction of the negative active material layer and simultaneously, may help maintain high electronic conductivity in the negative active material layer. As a result, the cycle-life of the rechargeable lithium battery may be improved.

The carbon-based material and the silicon-based material may be provided in a suitable amount and mixing ratio. For example, the silicon-based material may be used in an amount of about 1 wt % to about 10 wt % based on the total amount of the negative active material layer.

The carbon-based material may be, for example, a graphite-based material such as artificial graphite, natural graphite, a mixture of artificial graphite and natural graphite, natural graphite coated with artificial graphite, or the like.

The silicon-based material may be, for example, silicon, silicon oxide, a silicon-containing alloy, a mixture of a graphite-based material and one or more of these material, or the like. The silicon oxide may be represented by SiOₓ (0.5≦x≦1.5). The silicon-containing alloy may include silicon in the largest amount among all the metal elements based on total amount of the alloy. For example, the silicon-containing alloy may be a Si—Al—Fe alloy or the like.

The tin-based material may include, for example, tin, a tin oxide, a tin-containing alloy, a mixture with a graphite-based material, or the like.

The lithium metal oxide may include, for example, a titanium oxide compound such as Li₄Ti₅O₁₂, or the like.

The water-soluble polymer may be used as a thickener. The water-soluble polymer may include, for example, a cellulose-based polymer, a polyacrylic acid-based polymer, polyvinyl alcohol, polyethyleneoxide or the like. These may be used singularly or in a mixture of two or more. For example, the cellulose-based polymer may further improve binding strength among the negative active materials.

The cellulose-based polymer may include, for example, a metal salt of a cellulose derivative such as carboxymethyl cellulose, methyl cellulose, ethyl cellulose, hydroxyalkyl cellulose or the like. Of these, the metal salt of carboxymethyl cellulose may further improve the binding strength among the negative active materials.

The negative electrode 30 including such a water-soluble polymer may be referred to as an aqueous negative electrode.

The fluorine-based polymer particulate may include a fluorine-based polymer. The fluorine-based polymer may be used as a binder in the negative active material layer 32. The fluorine-based polymer particulate may be dispersed in the negative active material layer 32 and simultaneously, may bind the negative active materials.

The fluorine-based polymer particulate may be adhered to the outmost surface of the negative active material layer 32, for example, on the surface of the negative electrode 30 that contacts the second coating layer 40c of the separator. The fluorine-based polymer particulate at the outmost surface of the negative active material layer may also be adhered to the second coating layer 40c of the separator and thus, may firmly bind the second coating layer 40c of the separator with the negative active material layer 32.

The fluorine-based polymer may not dissolve well in water, but the fluorine-based polymer particulate may be well dispersed in water and may form a latex. Thus, the fluorine-based polymer particulate may be uniformly dispersed in the negative active material layer. The aqueous negative electrode using water as a solvent dispersing the negative electrode active mass may be realized.

The fluorine-based polymer including the fluorine-based polymer particulate may have crystallinity. Examples of such a fluorine-based polymer may include polyvinylidene fluoride (PVDF), a vinylidenefluoride (VDF)-hexafluoropropylene (HFP) copolymer, a vinylidenefluoride (VDF)-tetrafluoroethylene (TFE) copolymer, or a vinylidenefluoride (VDF)-tetrafluoroethylene (TFE)-hexafluoropropylene (HFP) copolymer. These may be used singularly or as a mixture of two or more. If the vinylidenefluoride (VDF)-hexafluoropropylene (HFP) copolymer is used, a weight ratio between vinylidenefluoride and hexafluoropropylene may be adjusted to a degree that the fluorine-based polymer is not dissolved in the non-aqueous electrolyte.

The crystalline fluorine-based polymer particulate may be hardly swollen by an electrolyte. A swelling rate may be obtained, for example, by dividing the volume of a resin before dipping the resin in the electrolyte by the volume of the resin after the dipping the resin in the electrolyte. The fluorine-based polymer particulate according to an embodiment may firmly bind the negative active materials even after being swollen by the electrolyte.

The fluorine-based polymer in the fluorine-based polymer particulate may be the same kind as the fluorine-based polymer included in the second coating layer 40c of the separator. For example, the fluorine-based polymer particulate used for the negative active material layer 32 and the fluorine-based polymer used for the second coating layer 40c of the separator may each include polyvinylidene fluoride (PVDF), The bonding strength between the negative active material layer 32 and the second coating layer 40c may be further improved, and thus, buckling resistance of the rechargeable lithium battery may be improved.

When the fluorine-based polymer particulate, for example, a particulate of the fluorine-based polymer is regarded as having a spherical shape, the particulate may have a suitable particle diameter for being dispersed into the negative active material layer 32. For example, the fluorine-based polymer particulate may have an average particle diameter (an arithmetic average particle diameter) of about 150 nm or so.

The average particle diameter of the fluorine-based polymer particulate may be measured, for example, by a laser diffractometry method. The particle diameter distribution of the fluorine-based polymer particulate may be obtained in the laser diffractometry method, and its average particle diameter may be calculated based on the particle diameter distribution. Herein, the term “average particle diameter” refers to an arithmetic mean of the particle diameters before fusing.

The fluorine-based polymer particulate may be prepared by, for example, emulsion-polymerizing a monomer providing a fluorine-based polymer or by suspension-polymerizing a monomer providing a fluorine-based polymer and then, grinding agglomerated particles obtained therefrom. The fluorine-based polymer-providing monomer may include, for example, vinylidenefluoride (VDF) or the like. This method may easily provide a fluorine-based polymer particulate having a very small particle diameter.

The fluorine-based polymer particulate may be included in an amount of about 1 wt % to about 10 wt %, or, for example, about 1.5 wt % to about 10 wt %, about 2 wt % to about 10 wt %, about 3 wt % to about 10 wt %, about 4 wt % to about 10 wt %, or about 6 wt % to about 10 wt % based on the total amount of the negative active material layer. When the fluorine-based polymer particulate is included within the range, excellent binding strength between the negative active material layer 32 and the second coating layer 40c may be obtained, and high energy density of a battery may be secured. The negative active material layer may have sufficient negative active material density.

The negative active material layer may be formed, for example, by the following method.

The negative active material, the water-soluble polymer and the fluorine-based polymer particulate may be dispersed into water to prepare negative electrode active mass slurry. This negative electrode active mass slurry may be coated onto a current collector and then, dried. In the negative electrode active mass slurry, the fluorine-based polymer particulate may be dispersed in the negative active material layer and simultaneously adhered on the surface of the negative active material. Subsequently, the dried negative electrode active mass may be compressed with the current collector 31.

In addition, a film obtained after the compression may be heated at a temperature greater than or equal to a melting point of the fluorine-based polymer particulate, such that the fluorine-based polymer particulate may be adhered to the surface of the negative active material, and the negative active material may be firmly bound together. For example, when polyvinylidene fluoride (PVDF), which has a melting point of about 165° C., is used to form the fluorine-based polymer particulate, the film may be heated at about 170° C. after the compression. The fluorine-based polymer particulate may be adhered to the outmost surface of the negative active material layer 32.

The fluorine-based polymer particulate may be distributed with a surface density of about 8/μm² (eight of the fluorine-based polymer particulate per μm²) on the outermost surface of the negative active material layer 32, for example, the surface facing the second coating layer 40c of the separator 40.

As an example, the surface density may be measured as follows.

More than one observation region with a size of about 10 μm² on the outmost surface of the negative active material layer 32 may be examined with a scanning electron microscope (SEM), and the number of the fluorine-based polymer particulate in each region may be counted. Then, the total number of the fluorine-based polymer particulate may be divided by the total areas of the observation regions, obtaining the surface density of the fluorine-based polymer particulate.

The positive electrode 20 may include a positive current collector 21 and a positive active material layer 22 formed on the positive current collector.

The positive current collector 21 may be a suitable conductor, and may include, for example, aluminum, stainless steel or nickel plated steel.

The positive current collector 21 may be connected to a positive current collector tab 110.

The positive active material layer 22 may include at least positive active material, and may further include a conductive agent and a binder.

The positive active material may be, for example a suitable material that electrochemically intercalates and deintercalates lithium ions. For example, the positive active material may be a solid solution oxide. The solid solution oxide may be, for example LiₐMnₓCo_{y}Ni_{z}O₂ (1.150≦a≦1.430, 0.45≦x≦0.6, 0.10≦y≦0.15, 0.20≦z≦0.28), LiMnₓCo_{y}Ni_{z}O₂ (0.3≦x≦0.85, 0.10≦y≦0.3, 0.10≦z≦0.3), LiMi_{1.5}Ni_{0.5}O₄, LiCoO₂, LiNiO₂, LiMn₂O₄, LiMnO₂, LiCo_{0.5}Ni_{0.5}O₂, LiNi_{0.7}Co_{0.2}Mn_{0.1}O₂, MnO₂, or the like.

The conductive agent may be a suitable material to improve conductivity, for example, carbon black, ketjen black, acetylene black, or the like, natural graphite, or artificial graphite, or the like.

The binder may be a suitable binder to bind the positive active material and the conductive agent on the current collector 21. Examples of the fluorine-based polymer include polyvinylidene fluoride (PVDF), polytetrafluoroethylene (PTFE), a vinylidenefluoride (VDF)-hexafluoropropylene (HFP) copolymer, a vinylidenefluoride (VDF)-tetrafluoroethylene (TFE) copolymer, a vinylidenefluoride (VDF)-chlorotrifluoroethylene (CTFE) copolymer, or the like. As other examples, an ethylene-propylene-diene terpolymer, a styrene-butadiene rubber (SBR), an acrylonitrile-butadiene rubber, polyvinylacetate, polymethylmethacrylate, polyethylene, nitrocellulose or the like may be used.

The binder may be the same kind as a fluorine-based polymer included in the first coating layer 40b of the separator 40. For example, both of the binders in the first coating layer 40b of the separator and in the positive active material layer may be polyvinylidene fluoride (PVDF). The binding strength between the first coating layer 40b of the separator and the positive active material layer 22 may be further improved, and buckling resistance of a rechargeable lithium battery may be improved.

The positive active material layer 22 may be formed, for example, by dry-mixing a positive active material, a conductive agent and a binder to prepare a positive electrode active mass, dispersing the positive electrode active mass into an appropriate organic solvent to prepare positive electrode active mass slurry, coating this positive electrode active mass slurry on a positive current collector 21 and drying and compressing positive electrode active mass slurry on the positive current collector.

The case 100 may house the positive electrode 20, the negative electrode 30 and the separator 40. The case 100 may be formed of an aluminum laminate film. According to an embodiment, low rigidity of the case may be complemented by the firm binding strength between the negative active material layer and the separator. Accordingly, the buckling resistance of the rechargeable lithium battery 10 may be improved.

The positive current collector tab 110 may be connected to the positive current collector 21 and may protrude out of the case 100. The negative current collector tab 120 may be connected to the negative current collector 31 and may protrude out of the case 100.

The rechargeable lithium battery 10 may include a laminate obtained by stacking the positive electrode 20, the negative electrode 30 and the separator 40 or may include a wound sheet obtained by stacking and winding the positive electrode 20, the negative electrode 30 and the separator 40. The rechargeable lithium battery 10 may have other structures.

Hereinafter, a method of manufacturing the rechargeable lithium ion battery 10 is illustrated.

A positive electrode 20 may be manufactured as follows.

A positive active material, a conductive agent and a binder may be mixed in a desirable ratio preparing a positive electrode active mass. Subsequently, the positive electrode active mass may be dispersed in an organic solvent such as N-methyl-2-pyrrolidone forming a positive electrode active mass slurry. Then, the positive electrode active mass slurry may be formed (for example, coated) on a current collector 21 and dried. Herein, the coating may be performed by a suitable method, such as by using, for example, a knife coater, a gravure coater, or the like. The following coating process may be performed with the same method. Subsequently, the dried film and the positive current collector may be pressed to have a desirable thickness by using a press forming a positive electrode 20 with the positive active material layer 22 having a suitable thickness. A positive current collector tab 110 may be welded into the positive current collector.

A negative electrode 30 may be manufactured as follows.

A negative active material, a water-soluble polymer and a fluorine-based polymer particulate may be mixed in a desirable ratio preparing a negative electrode active mass. Subsequently, the negative electrode active mass may be dispersed in water to form a negative electrode active mass slurry. Then, the negative electrode active mass slurry may be formed (for example, coated) on a negative current collector 31 and dried. Then, the dried film and the negative current collector 31 may be pressed to have a desirable thickness by using a press. Then, the negative electrode active mass may be heated at a temperature of greater than or equal to the melting point of the fluorine-based polymer particulate, thereby forming a negative electrode 30. Then, a negative current collector tab 120 may be welded into the negative current collector 31.

On one side or both sides of the substrate 40a, a fluorine-based polymer solution, for example, a solution obtained by dispersing polyvinylidene fluoride (PVDF) into N-methyl-2-pyrrolidone, may be coated. Subsequently, the fluorine-based polymer may be coagulated by washing the substrate 40a with water or the like, and then dried. A second coating layer 40c on one side of the substrate 40a or the first and second coating layers 40b and 40c on both sides of the substrate 40a may be formed, obtaining the separator 40.

Subsequently, the separator may be disposed between the positive and negative electrodes, manufacturing an electrode structure sheet. Subsequently, the electrode structure sheet may be processed into a laminate. For example, the electrode structure sheet may be wound and pushed down, obtaining a wound element. Then, this wound element may be inserted into the case 100. The positive current collector tab 110 and the negative current collector tab 120 may protrude out of the case 100. Subsequently, the case 100 except for an inlet may be thermally fused. Subsequently, an electrolyte may be injected into the case 100 through the inlet to impregnate each pore in the separator with the electrolyte. Subsequently, the case 100 may be sealed and heated, manufacturing a rechargeable lithium battery.

The fluorine-based polymer particulate in the negative active material layer and the second coating layer 40c of the separator may absorb the electrolyte and may be swollen and adhered to each other. The first coating layer 40b of the separator may absorb the electrolyte and may be swollen and adhered to the binder in the positive active material layer 22. The case 100 may then be cooled. Each adhered part may be solidified and may firmly bind the separator 40 with the positive active material layer 22 or the negative active material layer 32.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### Manufacture of Positive Electrode

LiCoO₂, carbon black powder and polyvinylidene fluoride were dry-mixed in a weight ratio of 96:2:2, preparing a positive electrode active mass. Subsequently, the positive electrode active mass was dispersed into N-methyl-2-pyrrolidone, obtaining a positive electrode active mass slurry. Subsequently, the positive electrode active mass slurry was coated on both sides of a 13 μm-thick aluminum thin film. and then dried and compressed to form a positive active material layer on the current collector, manufacturing a positive electrode. Herein, the positive active material layer had charge density of 3.95 g/cm³ where coated on both sides of the positive current collector and a thickness of 140 μm.

(Manufacture of Negative Electrode)

Artificial graphite (MAG, Hitachi Ltd.), carboxymethyl cellulose sodium (CMC-Na) and a polyvinylidene fluoride (PVDF) particulate (Arkema Inc.) obtained by emulsion-polymerizing vinylidenefluoride were mixed in a weight ratio of 98:1:1, obtaining a negative electrode mass. Subsequently, the negative electrode mass was dispersed into water, obtaining negative electrode active mass slurry. The PVDF particulate had an average particle diameter of about 150 nm when measured by the aforementioned method. Subsequently, the negative electrode active mass slurry was coated on both sides of a 8 μm-thick copper foil, and then dried. Subsequently, the dried negative electrode mass was compressed with the negative current collector. Subsequently, the compressed negative electrode mass was heated at 170° C., a temperature that is greater than or equal to a melting temperature of the polyvinylidene fluoride (PVDF), to form a negative active material layer on the negative current collector, manufacturing a negative electrode. The negative active material layer had charge density of 1.65 g/cm³ where coated on both sides of the negative current collector. In addition, the PVDF particulate had surface density of 8/μm² when measured in the aforementioned method.

(Manufacture of Separator)

5 parts by weight of polyvinylidene fluoride (PVDF) (KF9300, KUREHA CORPORATION) was added to 100 parts by weight of N-methyl-2-pyrrolidone and completely dissolved therein through agitation. Subsequently, the solution was coated onto both sides of a 9 μm-thick polyethylene porous film using a dip coater, coagulated in a water tank, and then, dried to form a PVDF coating layer on both sides of the polyethylene porous film. The dried product had a total thickness 12 μm thick.

(Manufacture of Rechargeable Lithium Battery Cell)

The positive and negative electrodes and a separator were overlapped, wound in a length direction and pressed, manufacturing a flat-type wound battery cell. The battery cell was inserted into a case made of a 120 μm-thick three-layered (polypropylene/aluminum/nylon) laminate film, and an electrode terminal was provided to extend out of the case body through a thermal fuse. Then, an electrolyte solution obtained by mixing ethylene carbonate and diethyl carbonate in a volume ratio of 3:7 and dissolving 1.2 mol/L LiPF₆ in the solvent was injected into the case of the battery cell. The other side of the case was sealed under a reduced pressure through thermal coalescing. Then, the case was inserted between metal plates and heated at 80° C. for 3 minutes. Accordingly, a rechargeable lithium battery cell having a size of 3 mm thick×30 mm wide×30 mm high was manufactured.

### Examples 2 to 5

A rechargeable lithium battery cell was manufactured according to the same method as Example 1 except for changing the mixing weight ratio of artificial graphite, carboxymethyl cellulose sodium (CMC-Na) and polyvinylidene fluoride (PVDF) particulate as provided in the following Table 1 to manufacture the negative electrode.

### Comparative Example 1

A rechargeable lithium battery cell was manufactured according to the same method as Example 1 except for mixing artificial graphite, carboxymethyl cellulose sodium (CMC-Na) and a styrene-butadiene rubber (SBR) in a weight ratio of 98:1:1 to manufacture the negative electrode.

### Comparative Example 2

A rechargeable lithium battery cell was manufactured according to the same method as Comparative Example 1 except for using a 9 μm-thick polyethylene porous film without a coating layer as the separator.

### Comparative Example 3

A rechargeable lithium battery cell was manufactured according to the same method as Example 3 except for using a 9 μm-thick polyethylene porous film without a coating layer as the separator.

### Example 6

A rechargeable lithium battery cell was manufactured according to the same method as Example 1 except for using a negative electrode manufactured in the following method instead of the negative electrode according to Example 1.

A mixture of artificial graphite (MAG, Hitachi Ltd.) and SiO_{1.05} in a weight ratio of 97:3, carboxymethyl cellulose sodium (CMC-Na) and polyvinylidene fluoride (PVDF) particulate (Arkema Inc.) obtained by emulsion-polymerizing vinylidenefluoride were mixed in a weight ratio of 98:1:1, manufacturing a negative electrode mass. Subsequently, the negative electrode mass was dispersed into water, obtaining negative electrode active mass slurry. The PVDF particulate had an average particle diameter of about 150 nm when measured in the aforementioned method. Subsequently, the negative electrode active mass slurry was coated onto both sides of a 8 μm-thick copper foil and dried. Subsequently, the dried negative electrode mass along with a negative current collector was compressed. Subsequently, the compressed negative electrode mass was heated at 170° C. (greater than or equal to a melting point of the polyvinylidene fluoride (PVDF)) to form a negative active material layer on the negative current collector. The negative active material layer had charge density of 1.75 g/cm³ where coated on both sides of the negative current collector. In addition, the negative active material layer had a thickness of 137 μm.

### Examples 7 to 10

A rechargeable lithium battery cell was manufactured according to the same method as Example 6 except for adjusting the mixing weight ratio of the mixture of artificial graphite and SiO_{1.05} in a weight ratio of 97:3, the carboxymethyl cellulose sodium (CMC-Na) and the polyvinylidene fluoride (PVDF) particulate as provided in the following Table 2 to manufacture the negative electrode.

### Comparative Example 4

A rechargeable lithium battery cell was manufactured according to the same method as Example 6 except for mixing a mixture of artificial graphite and SiO_{1.05} in a weight ratio of 97:3, carboxymethyl cellulose sodium (CMC-Na) and a styrene-butadiene rubber (SBR) in a weight ratio of 98:1:1 to manufacture the negative electrode.

### Comparative Example 5

A rechargeable lithium battery cell was manufactured according to the same method as Comparative Example 4 except for using a 9 μm-thick polyethylene porous film without forming a coating layer as the separator.

Evaluation 1: SEM Analysis of Negative Electrode

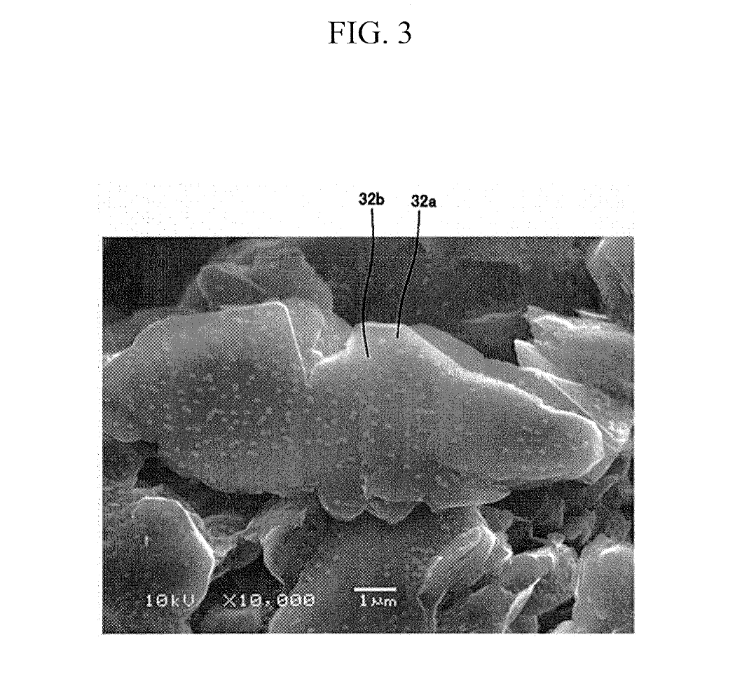

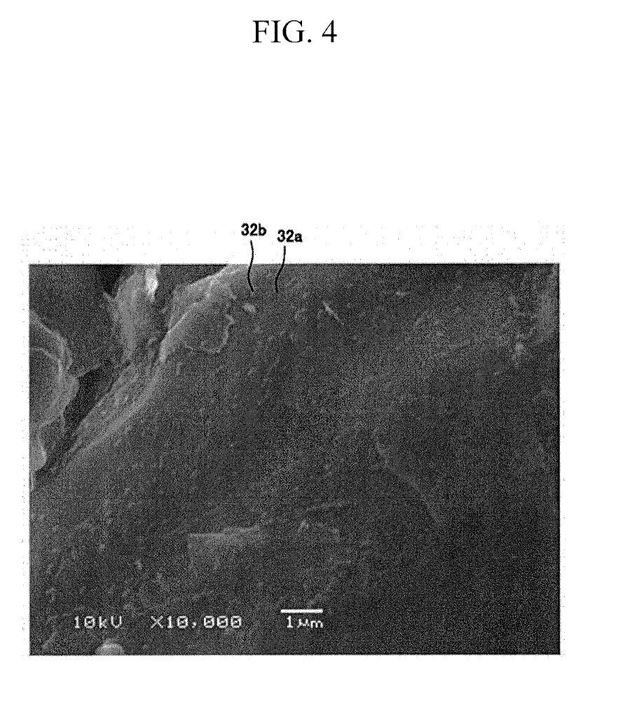

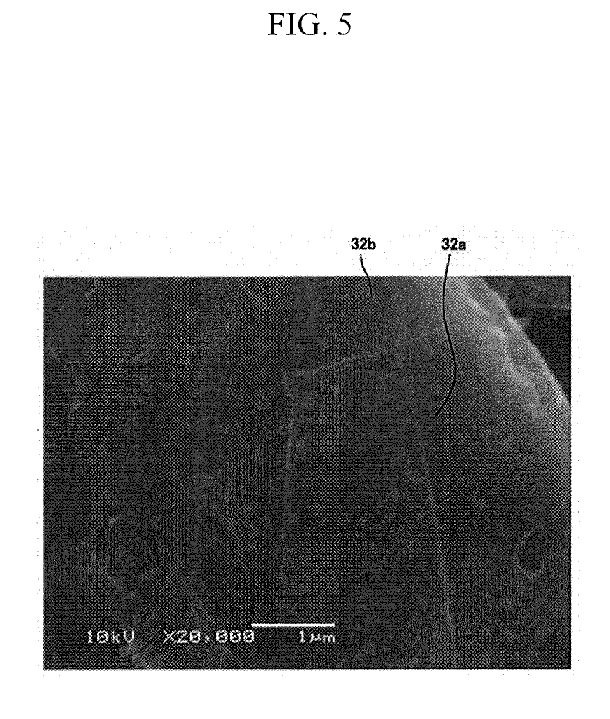

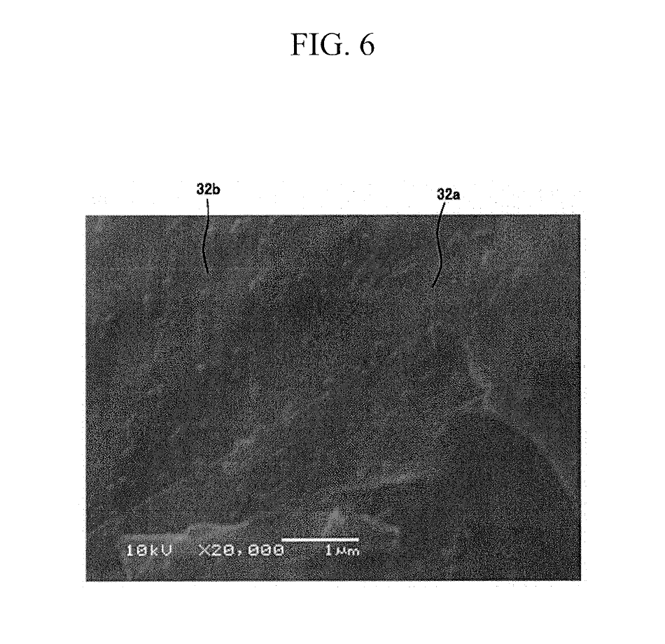

FIG. 3 provides a scanning electron microscope (SEM) image showing the negative electrode mass after the compression according to Example 1, and FIG. 4 provides a scanning electron microscope (SEM) image showing the negative electrode mass after being heated at 170° C. after the compression according to Example 1. In addition, FIG. 5 provides a scanning electron microscope (SEM) image showing the negative electrode after the compression according to Example 6, and FIG. 6 provides a scanning electron microscope (SEM) photograph showing the negative electrode after being heat-treated at 170° C. after the compression according to Example 6.

Referring to FIGS. 3 and 5, PVDF particulates 32b of fluorine-based polymer particulates were adhered on the negative active material 32a in the negative electrodes according to Examples 1 and 6. In addition, referring to FIGS. 4 and 6, PVDF particulates 32b of fluorine-based polymer particulates were adhered to the negative active material 32a in the negative electrodes according to Examples 1 and 6

Evaluation 2: Thickness Increase Rate of Battery Cell

Thicknesses of the rechargeable lithium battery cells according to Examples 6 to 10 and Comparative Examples 4 and 5 before being charged, and the thicknesses thereof during the initial charge, were measured by putting the rechargeable lithium battery cells between two sheets of plates applied with a load of 300 g.

In the following Table 1, the thickness increase ratio (%) was obtained as a percentage of the thickness of the battery cell during the initial charge relative to thickness of a battery cell before the initial charge. Herein, the battery thickness indicates thickness of a battery cell in a direction of stacking electrodes.

Evaluation 3: Cycle-Life

The rechargeable lithium battery cells according to Examples 1 to 10 and Comparative Examples 1 to 5 were constant current-charged at 56 mA up to 4.35 V, constant voltage-charged up to a charge current of 14 mA and then, constant current-discharged at 56 mA down to a cut-off voltage of 2.75 V at 25° C. Herein, the discharged electricity amount of a battery cell was defined as initial discharge capacity.

After measuring the initial discharge capacity, the battery cells were charged at 280 mA up to 4.35 V in a 25° C. thermostat, constant voltage-charged up to a current of 14 mA, and then, constant current-discharged at 280 mA down to 2.75 V. After 300 times charging and discharging the battery cells according to Examples 1 to 5 and Comparative Examples 1 to 3 and 100 times charging and discharging the battery cells according to Examples 6 to 10 and Comparative Examples 4 and 5 as above, their discharge capacity after charge and discharge at 25° C. was measured under the same condition as the initial discharge capacity, and the results are provided in the following Tables 1 and 2.

In the following Table 1, each capacity retention (%) of the battery cells according to Examples 1 to 5 and Comparative Examples 1 to 3 was obtained as a percentage of discharge capacity at the 300th charge and discharge relative to the initial discharge capacity, and each capacity retention (%) of the battery cells according to Examples 6 to 10 and Comparative Examples 4 and 5 was obtained as a percentage of discharge capacity at the 100th charge and discharge relative to the initial discharge capacity

Evaluation 4: Buckling Test

After the initial discharge capacity of rechargeable lithium battery cells according to Examples 1 to 10 and Comparative Examples 1 to 5 was measured, the buckling strength was measured using an AGS-X, a desktop precise universal testing machine manufactured by Shimadzu Corporation. Specifically, the rechargeable lithium battery was loaded in a jig having a gap 15 mm, and an indenter having a gap diameter curvature of 2 mmφ and width of 30 mm was disposed in parallel to the winding element. The load was measured when pushing the indenter in a direction below the indenter at 5 mm/minute, and the maximum load was considered as a buckling point of a rechargeable lithium battery to determine the buckling strength. The results are shown in the following Tables 1 and 2.

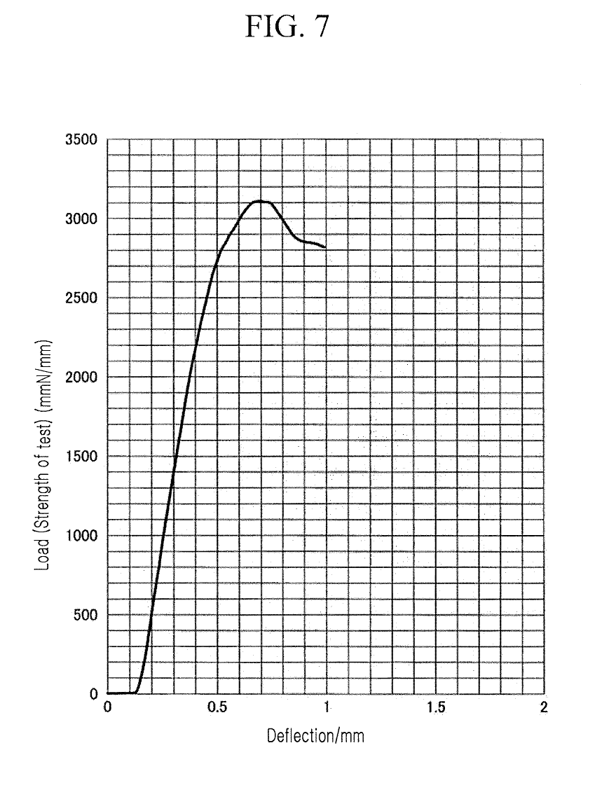

FIG. 7 is a graph showing the correlation between the indenter deflection and the load (strength of test) loaded in the indenter in the buckling test of a rechargeable lithium battery.

In FIG. 7, since the rechargeable lithium battery was buckled at a load of 3100 mN, the rechargeable lithium battery had a buckling intensity of 3100 mN.

TABLE 1

| | | Comparative Example | | | Example | | | | |
|---|---|---|---|---|---|---|---|---|---|
| | | 1 | 2 | 3 | 1 | 2 | 3 | 4 | 5 |
| Separator | Coating layer | Yes | No | No | Yes | Yes | Yes | Yes | Yes |
| Negative | Graphite | 98 | 98 | 96.45 | 98 | 97.3 | 96.45 | 94 | 89 |
| electrode | (wt %) | | | | | | | | |
| | CMC-Na | 1 | 1 | 1 | 1 | 1 | 1 | 1 | 1 |
| | (wt %) | | | | | | | | |
| | SBR (wt %) | 1 | 1 | 0 | 0 | 0 | 0 | 0 | 0 |
| | PVDF | 0 | 0 | 2.55 | 1 | 1.7 | 2.55 | 5 | 10 |
| | particulate | | | | | | | | |
| | (wt %) | | | | | | | | |

| | | | | | | | | |
|---|---|---|---|---|---|---|---|---|
| Buckling strength (mN/mm) | 3000 | 1300 | 1500 | 3800 | 4300 | 5200 | 6000 | 6200 |
| Capacity retention (%) | 46.2 | 36.9 | 50.1 | 55.9 | 57.6 | 59.1 | 60.1 | 58.9 |

TABLE 2

| | | | Comparative | | | | | | |
|---|---|---|---|---|---|---|---|---|---|
| | | | Example | | Example | | | | |
| | | | 4 | 5 | 6 | 7 | 8 | 9 | 10 |
| Separator | Coating layer | | Yes | No | Yes | Yes | Yes | Yes | Yes |
| Negative | Active | SiOₓ (wt %) | 2.94 | 2.94 | 2.94 | 2.92 | 2.89 | 2.82 | 2.67 |
| electrode | material | Graphite (wt %) | 95.06 | 95.06 | 95.06 | 94.38 | 93.56 | 91.18 | 86.33 |

| | | | | | | | |
|---|---|---|---|---|---|---|---|
| CMC-Na (wt %) | 1 | 1 | 1 | 1 | 1 | 1 | 1 |
| SBR (wt %) | 1 | 1 | 0 | 0 | 0 | 0 | 0 |
| PVDF particulate (wt %) | 0 | 0 | 1 | 1.7 | 2.55 | 5 | 10 |

| | | | | | | | |
|---|---|---|---|---|---|---|---|
| Buckling strength (mN/mm) | 2700 | 1200 | 3400 | 3900 | 4700 | 5400 | 6200 |
| Thickness increase ratio (%) | 21 | 25 | 12 | 12 | 11 | 10 | 10 |
| Capacity retention (%) | 91 | 90 | 94 | 94 | 93 | 93 | 92 |

Referring to Table 1, the rechargeable lithium battery cells of Examples 1 to 5 respectively including a negative electrode manufactured by using a negative active material, a water-soluble polymer and a fluorine-based polymer particulate and a separator having a coating layer including a fluorine-based polymer according to an embodiment maintained excellent cycle-life characteristics, and simultaneously showed remarkably improved buckling strength compared with the battery cell of Comparative Example 1 including no fluorine-based polymer particulate in a negative electrode, the battery cell of Comparative Example 3 including a separator having no coating layer and the battery cell of Comparative Example 2 including no fluorine-based polymer particulate in a negative electrode and a separator having no coating layer. Without being bound to any particular theory, it is believed that the battery cells of Examples 1 to 5 provided excellent characteristics because the fluorine-based polymer particulate in a negative active material layer was fused with the coating layer formed in the separator to firmly bind the negative active material layer with the separator.

In addition, when the fluorine-based polymer particulate was included within a range of 1 wt % to 10 wt % in the negative active material layer, the more the fluorine-based polymer particulate was included, the more the buckling strength and cycle-life characteristics were improved.

In addition, referring to Table 2, the rechargeable lithium battery cells according to Examples 6 to 10 respectively including a negative electrode including a negative active material, a water-soluble polymer and a fluorine-based polymer particulate and a separator having a coating layer including a fluorine-based polymer according to an embodiment showed excellent cycle-life characteristics and a small thickness increase ratio compared with the battery cell of Comparative Example 4 including no fluorine-based polymer particulate in a negative electrode and the battery cell of Comparative Example 5 including no fluorine-based polymer particulate in a negative electrode and a separator having no coating layer. Without being bound to any particular theory, it is believed that in the battery cells of Examples 6 to 10, the fluorine-based polymer particulate in a negative active material layer firmly bound with negative active materials and with one another and suppressed expansion/contraction of a silicon-based active material and simultaneously, maintained linkage of the negative active materials. In addition, the rechargeable lithium battery cells according to Example 6 to 10 showed remarkably improved buckling strength compared with those of Comparative Examples 4 and 5. It is believed that the fluorine-based polymer particulate in the negative active material layer was adhered to the coating layer formed on the separator toward the negative electrode and thus, firmly bound with the negative active material layer with the separator.

In addition, when the fluorine-based polymer particulate was used within the range of 1 wt % to 10 wt % in the negative active material layer, and the more the fluorine-based polymer particulate was included, the higher the buckling strength became, but the lower the thickness increase ratio became.

By way of summation and review, to provide a rechargeable lithium battery having a slim size, an aluminum laminate film is used as an external material for the rechargeable lithium battery. The aluminum laminate film as the external material may easily provide a thin film rechargeable lithium battery due to a high degree of freedom in a battery size design. However, the aluminum laminate film has low rigidity, and so, there is a limit for improving the rigidity of a rechargeable battery when using the same as an external material.

To address environmental issues and high costs, a non-aqueous electrolyte rechargeable battery may be provided. The non-aqueous electrolyte rechargeable battery may be manufactured, for example, by using a separator retaining a gel-type non-aqueous electrolyte solution. In addition, the negative electrode may be manufactured by using an aqueous slurry. The aqueous slurry may be obtained by dispersing a water-soluble polymer, a latex polymer and a negative active material into water. The negative electrode may be manufactured by coating the aqueous slurry on a current collector and drying it. A negative electrode manufactured by using the aqueous slurry is also called as an aqueous negative electrode.

However, a rechargeable battery using the aqueous negative electrode may have low bending resistance (‘buckling resistance’) and specifically, may have low binding strength between the aqueous negative electrode and the separator compared with a rechargeable battery using negative electrodes other than the aqueous negative electrode. When the non-aqueous electrolyte rechargeable battery includes the aqueous negative electrode and simultaneously uses the aluminum laminate film as an external material, buckling resistance of the non-aqueous electrolyte rechargeable battery may be largely deteriorated.

For preventing expansion of an aqueous negative electrode during charging and discharging. a fluoro rubber including a water-soluble binder resin and a fluorinated resin copolymer, a graphite carbon material, and SiOx may be dispersed in water to prepare an aqueous-based slurry and a negative electrode is prepared by using the slurry. However, fluoro rubber has extremely large swelling properties with respect to the non-aqueous electrolyte inside the battery, so the fluoro rubber may not provide the sufficient mechanical strength.

Embodiments advance the art by providing a rechargeable lithium battery having excellent buckling resistance and cycle-life characteristics, by improving the binding strength of an aqueous negative electrode with a separator.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope of the present invention as set forth in the following claims.

What is claimed is:

1. A rechargeable lithium battery, comprising
a negative electrode including a negative active material layer; and
a separator including a substrate and a coating layer formed on at least one side of the substrate,
wherein the coating layer includes a fluorine-based polymer,
the coating layer faces the negative active material layer, and
the negative active material layer includes a negative active material, a water-soluble polymer and a fluorine-based polymer particulate.

2. The rechargeable lithium battery as claimed in claim 1, wherein the fluorine-based polymer particulate is included in the negative active material layer in an amount of about 1 wt % to about 10 wt % based on the total amount of the negative active material layer.

3. The rechargeable lithium battery as claimed in claim 1, wherein the fluorine-based polymer particulate is fused at an outermost surface of the negative active material layer.

4. The rechargeable lithium battery as claimed in claim 1, wherein the fluorine-based polymer particulate and the fluorine-based polymer are each independently polyvinylidene fluoride (PVDF), a vinylidenefluoride (VDF)-hexafluoropropylene (HFP) copolymer, a vinylidenefluoride (VDF)-tetrafluoroethylene (TFE) copolymer, a vinylidenefluoride (VDF)-tetrafluoroethylene (TFE)-hexafluoropropylene (HFP) copolymer, or a combination thereof.

5. The rechargeable lithium battery as claimed in claim 1, wherein the fluorine-based polymer particulate is obtained by emulsion polymerization of a monomer providing the fluorine-based polymer.

6. The rechargeable lithium battery as claimed in claim 1, wherein the fluorine-based polymer particulate is obtained by pulverizing agglomerated particles synthesized by suspension polymerization of a monomer providing the fluorine-based polymer.

7. The rechargeable lithium battery as claimed in claim 1, wherein the water-soluble polymer includes a cellulose-based polymer.

8. The rechargeable lithium battery as claimed in claim 7, wherein the cellulose-based polymer includes a metal salt of carboxymethyl cellulose.

9. The rechargeable lithium battery as claimed in claim 1, wherein the negative active material includes a silicon-based material, a carbon-based material, or a combination thereof.

10. The rechargeable lithium battery as claimed in claim 9, wherein the silicon-based material includes a silicon oxide represented by SiOₓ (0.5≦x≦1.5).

11. The rechargeable lithium battery as claimed in claim 1, wherein the fluorine-based polymer is a gel-type polymer swelled by a non-aqueous electrolyte.

12. The rechargeable lithium battery as claimed in claim 1, further comprising a case that houses the negative electrode and the separator, the case being formed of an aluminum laminate film.
